(19) United States
(12) Patent Application Publication
(10) Pub. No.: US 2018/0053246 A1
(43) Pub. Date: Feb. 22, 2018

(54) PRODUCE SELECTION SYSTEM FOR SINGLE ITEMS

(71) Applicant: Wal-Mart Stores, Inc., Bentonville, AR (US)

(72) Inventors: Steven Lewis, Bentonville, AR (US); Nicholaus Adam Jones, Fayetteville, AR (US); Matthew Dwain Biermann, Fayetteville, AR (US)

(21) Appl. No.: 15/673,483

(22) Filed: Aug. 10, 2017

Related U.S. Application Data
(60) Provisional application No. 62/377,341, filed on Aug. 19, 2016.

(51) Int. Cl. G06Q 30/06; H04N 5/232; H04N 13/02

(52) U.S. Cl. CPC G06Q 30/0643; G06Q 30/0635; G06F 3/04842; H04N 13/026; H04N 5/23238

(57) ABSTRACT

Disclosed is a system and method for online ordering of produce items by customers. The system allows customers to visually inspect the produce they are ordering. The system is useful for picking single, rounded produce items. The system includes a camera and rollers beneath a compartment grid to take images of produce for customer online selection.

### RELATED APPLICATIONS

This application claims the benefit of U.S. Provisional Patent No. 62/377,341, filed Aug. 19, 2016, entitled “Produce Selection System for Single Items,” the contents of which are incorporated by reference herein in their entirety.

### FIELD OF THE INVENTION

The invention relates generally to a produce selection system for single items, and specifically to a system and method of selecting single produce items.

### BACKGROUND

Online orders of produce are hit or miss for customers. Since customers cannot see which item they will be purchasing, there may be times where a customer is not happy with the produce item selected for them by the associate. Customers therefore tend to avoid ordering produce online. It is desirable for customers to be able to visually inspect the produce they are ordering.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a pictorial diagram of the produce selection according to the invention; and

FIG. 2 illustrates a block flow diagram of the method according to the invention.

### DETAILED DESCRIPTION

Disclosed herein is a system for item selection comprising an imaging device; a compartment grid repository having individual grid compartments; at least one item in at least one of the individual grid compartments; and a plurality of rollers in the bottom of the compartment grid repository, wherein the plurality of rollers rotates the at least one item in the at least one of the individual grid compartments. The plurality of rollers may be beneath the at least one item. The imaging device may capture images of the at least one item as the plurality of rollers rotate the at least one item. The system may comprise a selection light in each of the individual grid compartments. The selection light may be an LED light. The at least one item may be produce.

Disclosed is a method of selecting at least one item comprising placing at least one item into an individual grid compartment of a compartment grid repository; taking a first image of the at least one item in the individual grid compartment of the compartment grid repository with an imaging device; turning a plurality of rollers in the compartment grid repository to rotate the at least one item a portion of a complete rotation; taking a second image of the at least one item with the imaging device; providing a set of images comprising the first image and the second image to a customer via a customer interface on a customer device; selecting the at least one item from the set of images; and illuminating a selection light in the individual grid compartment of the at least one item selected. The method may further comprise collecting at least one item selected. The method may further comprise completing the order for customer pick up. The method may further comprise restocking at least one item in the individual grid compartment. The method may further comprise taking a third image of the at least one item. The first, second and third images may be 2D. The set of images may be a 3D composite of the first, second and third 2D images. The at least one item may be produce. The produce may be rounded. The selection light may be an LED light. The selection light may also be one of a set of selection lights.

In some embodiments a customer may simply choose the type of produce they want to purchase. The associate then selects produce for the customer at the time of order fulfillment. The system allows the customer to pick for themselves exactly which produce they want to purchase. The system allows the customer to visually inspect and choose the exact produce item they want to purchase and ensure it is the item the associate chooses for them. The associate may, for example, be a retail store associate, a warehouse associate, an online distribution center associate, and/or a third party associate.

In the present invention, the associate places single produce items into a grid repository having grid compartments. A camera takes a photo of all the single produce items in the grid compartments. Rollers turn the produce a portion of rotation. The camera then takes another photo. If the produce has not been rotated a full 360 degrees, the rollers turn the produce another portion of a rotation and the camera takes another photo. When the produce has been rotated 360 degrees, a photoset or rendered image is sent to the customer facing interface.

The customer selects the produce they want to purchase from a photo grid. A light is illuminated on the selected produce compartment and that produce is no longer selectable within the customer interface to prevent other customers from selecting and buying the selected produce. Data is sent to the collection point on which the customer requested which produce. An indicator or selection light is set when the associate starts to pick the order. The customer order is completed and given to them. If there is no produce, the associate restocks the grid with fresh produce.

A camera is mounted above the compartment grid repository. In some embodiments, more than one camera may be mounted above the compartment grid repository, for example above each individual grid compartment. The compartment grid repository includes rows of horizontal and vertical individual grid compartments, wherein each individual grid compartment is capable of holding a single item. The rollers are rotatable beneath the single items. The single items sit directly on the rollers. The rollers are beneath the rows of horizontal individual grid compartments and are operated by conventional drive means.

Each grid compartment has at least one LED light for signifying the status of the box and connected to the back end side of the system. In particular, each grid compartment may have a set of three LED lights in different colors. For example, a green light indicating when the single item is available for sale, a red light indicating when the single item is sold, a blue light indicating when the associate needs to fulfill the order and no light when the grid compartment is empty and needs to be restocked with a single item.

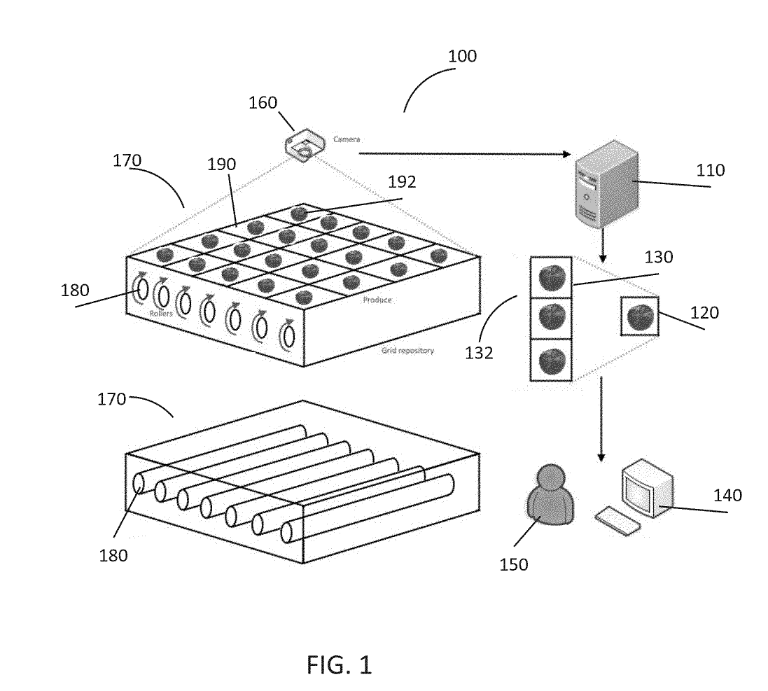

In FIG. 1 produce selection system 100 includes compartment grid repository 170 having individual grid compartments 190. Rollers 180 in compartment grid repository 170 rotate produce 192. Camera 160 takes at least one two dimensional (2D) image 130 of produce 192, particularly a set of three 2D images 132 for use in creating a single three dimensional (3D) composite image 120 for each individual grid compartment. Rollers 180 are beneath produce 192 in compartment grid 170. Images from camera 160 are sent to server 110 having a photo analysis module for processing. Photo analysis module of server 110 creates a 3D composite image 120 from three separate 2D photos of produce 130 in compartment grid repository 170. Customer 150 views separate 2D photos and/or composite 3D image 120 on a computing device 140 and orders the selected produce online.

Server 110 includes a photo analysis module. Server 110 is coupled to camera 160, and receives photos from camera 160. The photo analysis module receives at least one two dimensional photo 130, such as a set of three two dimensional photos 132 for each individual grid compartment from camera 160, and sends at least one two dimensional photo and/or three dimensional composite image 120 to computing device 140 in response.

In some embodiments, the photo analysis module of server 110 is designed and configured to recognize the at least one two dimensional photo 130, analyze the at least one two dimensional photo 130, and form a three dimensional composite image 120 from the at least one two dimensional photo 130.

In some embodiments, the photo analysis module of server 110 is designed and configured to recognize the set of two dimensional photos 132, analyze the set of two dimensional photos 132, and form a three dimensional composite image 120 from the set of two dimensional photos 130.

Computing device 140 may be any type of computing device such as a desktop or mobile computing device. In this embodiment, computing device 140 is a desktop computing device, but this is not meant to be limiting. Computing device 140 may be a mobile computing device, such as a mobile phone, a tablet, a handheld computer, a portable scanner, or any other mobile computing device with the ability to communicate with server 110.

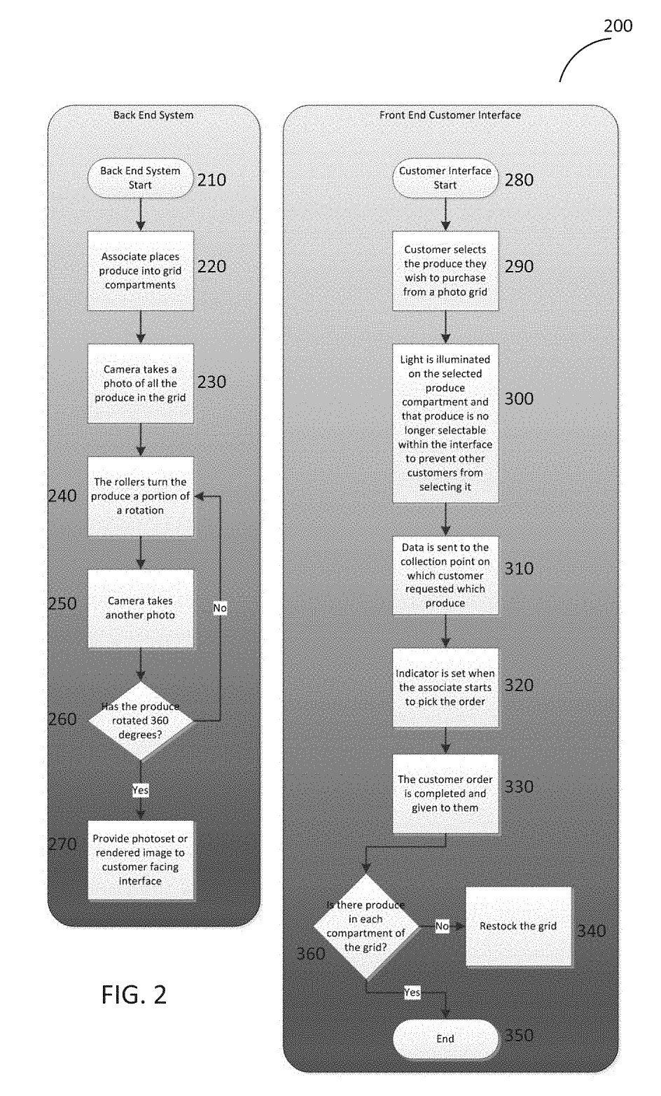

FIG. 2 illustrates method 200 of selecting single items, such as single rounded produce. Back end store system starts 210. Associate places the produce into grid compartments of compartment grid repository 220. A camera takes a two dimensional photo of all the produce in the compartment grid repository 230. Rollers turn the produce a portion of rotation 240 and the camera takes another photo 250. The system checks if the produce has rotated 360 degrees 260. If the produce have not have not rotated 360 degrees 260, the rollers turn the produce another portion of a rotation and the camera takes another photo 250. When the produce have been rotated 360 degrees, a photoset or rendered image is sent to a customer facing interface 270.

Customer interface starts 280. Customer selects the produce they want to purchase from a photo grid 290. A light is illuminated on the selected produce compartment indicating that produce in that compartment is no longer selectable within the customer interface to prevent other customers from selecting and buying the selected produce 300 and the image(s) is no longer available to other customers. Data is sent to the collection point on which the customer requested which produce 310. An indicator or selection light is set when the associate needs to fulfill the order 320. The customer order is completed and customer receives order 330. The customer may pick up the order at a retail store and/or have the order delivered. The system checks if there is produce in each individual grid compartment of the compartment grid 360. If there is no produce in each of the grid compartments, the associate restocks the grid compartments with fresh produce 340. If there is produce in each compartment of the grid, the system ends 350.

As will be appreciated by one skilled in the art, aspects of the disclosed selection system for single items may be embodied as an electronic system, a method, or a computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language or conventional procedural programming languages, such as the “C” programming language or similar programming languages. The program code may execute entirely on the retail store's computer, partly on the store's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or hardware accelerators or application specific integrated circuits.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for item selection comprising:
an imaging device;
a compartment grid repository having individual grid compartments;
at least one item in at least one of the individual grid compartments; and
a plurality of rollers in the bottom of the compartment grid repository, wherein the plurality of rollers rotates the at least one item in the at least one of the individual grid compartments.

2. The system of claim 1, wherein the plurality of rollers are beneath the at least one item.

3. The system of claim 1, wherein the imaging device captures images of the at least one item as the plurality of rollers rotates the at least one item.

4. The system of claim 1, further comprising a selection light in each of the individual grid compartments.

5. The system of claim 4, wherein the selection light is an LED light.

6. The system of claim 1, further comprising a set of selection lights in each of the individual grid compartments.

7. The system of claim 1, wherein the individual grid compartments are in horizontal and vertical rows.

8. The system of claim 7, wherein the rollers are beneath the horizontal rows of the individual grid compartments.

9. The system of claim 1, wherein the at least one item is produce.

10. A method of selecting at least one item comprising:
placing the at least one item into an individual grid compartment of a compartment grid repository;
taking a first image of the at least one item in the individual grid compartment of the compartment grid repository with an imaging device;
turning a plurality of rollers in the compartment grid repository to rotate the at least one item a portion of a complete rotation;
taking a second image of the at least one item with the imaging device;
providing a set of images comprising the first image and the second image to a customer via a customer interface on a customer device;
selecting the at least one item from the set of images; and
illuminating a selection light in the individual grid compartment of the at least one item selected.

11. The method of claim 10, further comprising collecting the at least one item selected.

12. The method of claim 11, further comprising completing the order for customer pick up.

13. The method of claim 12, further comprising restocking the at least one item in the individual grid compartment.

14. The method of claim 10, further comprising taking a third image of the at least one item.

15. The method of claim 14, wherein the first, second and third images are two dimensional.

16. The method of claim 15, wherein the set of images is a three dimensional composite of the first, second and third two dimensional images.

17. The method of claim 10, wherein the at least one item is produce.

18. The method of claim 17, wherein the produce is rounded.

19. The method of claim 18, wherein the selection light is a LED light.

20. The method of claim 10, wherein the selection light is one of a set of selection lights.
